(19) United States
(12) Patent Application Publication
(10) Pub. No.: US 2008/0117451 A1
(43) Pub. Date: May 22, 2008

(54) Print service for IMS network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/717,392

(22) Filed: Mar. 13, 2007

(30) Foreign Application Priority Data
Nov. 7, 2006 (CN) 200610143982.5

(51) Int. Cl. G06F 3/12; G06F 15/00; G06K 1/00

(52) U.S. Cl. 358/1.15

(57) ABSTRACT

A print service for an IMS network or other public WAN facilitates the transfer of print data over the network from a remote wireless unit or other terminal to a printer system, for the automatic printout of hard copy documents. Upon receiving an authorized print request from the terminal, the print service negotiates establishment of a communication link for transfer of print data from the terminal to the printer system. The printer system may include, for example, a printer and print server. The terminal transmits the print data to the printer system, which automatically prints hard copy documents based on the print data, for later retrieval by the terminal user. This enables the user to remotely print documents from any location accessible through the network, without having to access a local printer or save documents for later printing.

This application is entitled to the benefit of and claims foreign priority under 35 U.S.C. § 119 from Chinese Patent Application No. 200610143982.5, filed Nov. 7, 2006, the disclosure of which is hereby incorporated by reference.

### FIELD OF THE INVENTION

The present invention relates to communications and, more particularly, to user services in an IMS-based network or other communication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

An IMS-based network 10 is shown in simplified form in FIG. 1. The IMS control architecture includes a home subscriber server (“HSS”) 12 and a call session control function (“CSCF”) 14, and may generally be divided into a services/application layer 16a, an IMS layer 16b, and a transport layer 16c. The HSS 12 is the central repository of all subscriber-specific authorizations and service profiles and preferences. The HSS 12 integrates several functions/elements, some of which may exist already (for example, in the home location register of wireless networks), including subscriber/user profile database, subscriber service permissions, authentication and authorization, subscriber preference settings, mobile authentication server, and the like. An SLF 18 (subscriber location function) is needed when multiple HSS's are used. The CSCF 14 carries out the primary SIP signaling functions in the network. The CSCF 14 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 20 host and execute services, and interface with the CSCF 14 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 22 interfaces the IMS 10 with circuit-switched networks 24 such as a public switched telephone network (“PSTN”). The gateway 22 may include a BGCF (breakout gateway control function), which is an SIP server that includes routing functionality based on telephone numbers, an SGW (signaling gateway) that interfaces with the signaling plane of the network 24, an MGCF (media gateway controller function) for call control protocol conversion, and an MGW (media gateway) that interfaces with the media plane of the circuit-switched network 24. An MRF 26 (media resource function) may be provided as a media source in the network, e.g., for multimedia conferencing, text-to-speech conversation and speech recognition, and real-time transcoding of multimedia data, e.g., conversion between different codecs.

At the transport layer 16c, the IMS layer 16b is connected to a core broadband IP network 28, possibly through the MRF 26 and/or an IMS gateway 30. The IMS gateway 30 may include an IMS application layer gateway 32 (“IMS-ALG”) and a translation gateway 34 (“TrGW”) for facilitating communications with networks using different versions of the Internet protocol, e.g., IPv4 and IPv6. The core IP network 28 is also connected to one or more external IP packet data networks 36 (“IP PDN”), e.g., the Internet, and to other networks such as a DSL or other wire-line network 38, wireless local area networks (“WLAN”) 40, and wireless networks 42. Typically, one or more intermediate network elements are used for facilitating these connections, such as a WLAN access gateway (“WAG”) and/or WLAN packet data gateway (“PDG”) 44, a serving GPRS support node (“SGSN”) 46 and gateway GPRS service node (“GGSN”) 48, and a digital subscriber line access multiplexer (“DSLAM”) and broadband access server (“BAS”) 50. The SGSN 46 is responsible for mobility management and IP packet session management. It routes user packet traffic from the radio network 42 to the appropriate GGSN 48, providing access to external packet data networks, in this case the core network 28. The DSLAM 50 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 50 connects the DSL network 38 with the core IP network 28.

The networks 38, 40, 42 may be functionally/logically connected to the CSCF 14 through various control/functional elements. For example, the IMS system may include a policy decision function (“PDF”) 52, which enables the access network to be managed using dynamic policies. Additional functional elements 54 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

In an IMS-based network, as is generally the case with other communication networks, user terminals 56a, 56b provide a means for users to communicate with one another over the network(s). Each terminal is an electronic device with hardware and/or software-based functionality for communicating over a network, and typically including user input/output means such as a keyboard and display. Examples include computers and wireless units such as mobile phones and wireless PDA's. When one terminal 56a initiates communication with another terminal 56b, various signaling procedures are automatically carried out by the network, according to the network's communication protocols, in an attempt to open a communication channel between the two terminals.

For printing hard copies of photos, word processing files, and other documents in an IMS or other network 10, users must be in the local vicinity of a printer 58a-58c. For example, as shown in FIG. 1, a terminal 56a may be directly connected to a printer 58a via a parallel port cable or USB cable, or the terminal 56a may be in local wireless communication with a printer 58b via a short-range wireless link, such as one established according to the Bluetooth™ wireless protocol using short-range transceivers. In another example, a terminal 56b is indirectly locally connected to a printer 58c via a local area network (“LAN”) 60 and print server 62. In all three cases, for printing hard copies the user must be located near the printer, in the same room or building. Otherwise, the document must be saved in local memory and printed out when the user next has access to a printer, e.g., the user must connect the terminal to the printer, access a program for printing the document, and print out the document. For wireless devices without a direct printer interface, the document must first be transferred to a terminal connected to the printer. This process can be cumbersome, and may be impracticable for wireless terminals lacking significant local memory/storage. In other words, absent the availability of a local printer, the wireless terminal may have less storage than required for storing the number of photos or other documents that the user would like to print out.

### SUMMARY OF THE INVENTION

An embodiment of the present invention relates to a system and method for transmitting data over an IMS (IP Multimedia Subsystem) or other public wide area network, e.g., for transferring print data over the network from a terminal to a printer system for the automatic printout of hard copy documents. Upon receipt of a print request from the terminal, an IMS network print service controller establishes a communication link for transfer of print data from the terminal to the printer system. (By “printer system,” it is meant one or more devices that (i) print hard copies of photos/images, text documents, or the like, and (ii) that are configured for network communication. One example is a network-connected print server and a printer connected thereto. “Print data” refers to data usable by a printer system for printing hard copy documents.) Subsequently, the terminal transmits the print data to the printer system over the network. The printer system automatically prints out hard copy documents based on the print data, for later retrieval by the user of the terminal or some other person. This enables the user to print documents from any remote location accessible through the wide area network, without having to access a local printer or save documents for later printing.

“Public wide area network” refers to a communication network covering a wide geographic area, for example, an area greater than a campus or other grouping of related, proximately situated buildings, which is accessible by a number of unrelated individuals/groups for general purpose communications. Thus, the print service of the present invention allows a user to print documents, even if the terminal and printer system are “electronically remote” from one another, e.g., not directly connected via a terminal-to-terminal connection or a local area network (LAN).

In another embodiment, for establishing the communication link, the print request generated by the terminal includes an identifier associated with the printer system. Based on the identifier, the print service determines if the printer system is available for remote printing. If so, the print request is forwarded to the printer system. When the print request is received by the printer system, the printer system determines if the print request is authorized, that is, whether the terminal or the user is authorized to send print data to the printer system for generating hard copies. If so, the printer system and/or network print service sends a print request answer message to the terminal, which contains a network address or other communication identifier of the printer system. For example, the network address might include a network IP address and/or a network port of the printer system. Subsequently, the terminal addresses the print data to the address contained in the print request answer message, for transmitting the print data to the printer system over the network. The determination of whether the terminal is authorized to send print data to the printer system may be carried out by the print service, based on information received from the printer system, e.g., a periodically updated list of authorized terminals or users.

In another embodiment, the printer system periodically transmits status messages to the print service. The status messages indicate whether the printer system is “on line” for printing hard copies based on received print data. If the print service receives a print request from a terminal and the associated printer system is off line, then the print request is denied or postponed.

In another embodiment, the print service system generates billing data relating to the transfer of the print data from the terminal to the printer system. The billing data is associated with the terminal, and may be used to charge the terminal user for costs associated with the print data transfer operation.

### BRIEF DESCRIPTION OF THE DRAWINGS

The present invention will be better understood from reading the following description of non-limiting embodiments, with reference to the attached drawings, wherein below:

FIG. 1 is a schematic view of an IMS (IP Multimedia Subsystem) network;

FIG. 2 is a schematic view of a print service system according to an embodiment of the present invention;

FIG. 3 is a signaling diagram showing operation of the print service system; and

FIGS. 4A and 4B are schematic diagrams of various embodiments of terminal application software, as relating to interoperation of the terminal with the print service.

### DETAILED DESCRIPTION

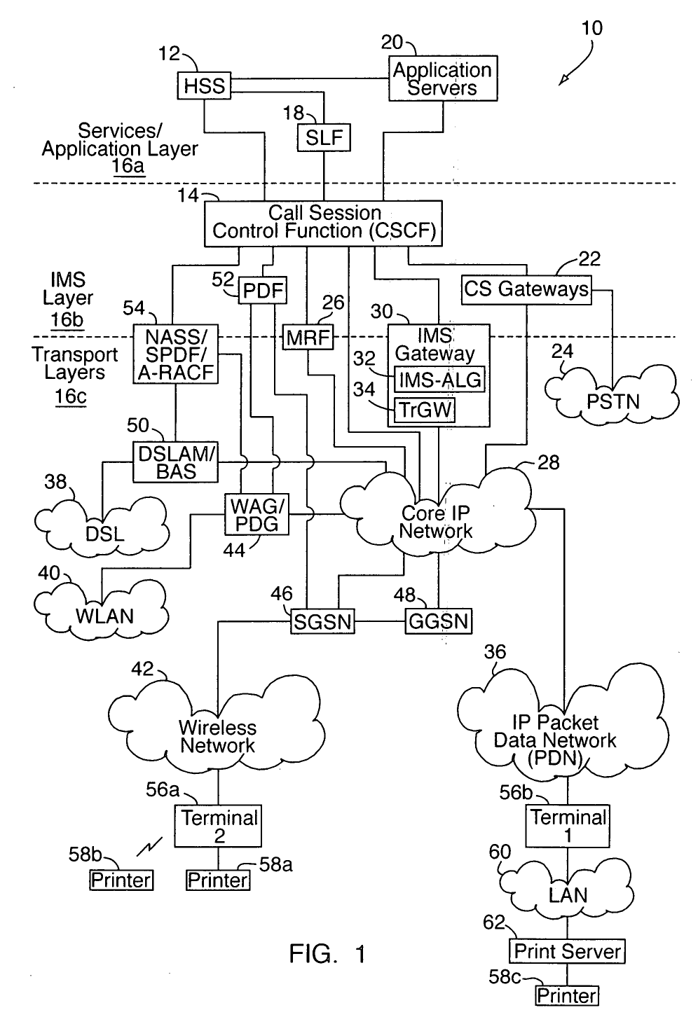

With reference to FIGS. 1-4B, a print service system 70 is implemented on or in conjunction with an IMS (IP Multimedia Subsystem) or other public wide area network 10. Using the system 70, a user may remotely print hard copy documents 72 at any location accessible to the user's terminal 74 through the network 10, without having to access a local printer or save documents for later printing. Upon receipt of an authorized print request 76 from the terminal 74, a print service controller or control sub-system 78 negotiates establishment of a communication link 80 for transfer of print data 82 from the terminal 74 to a printer system 84. (By “printer system,” it is meant one or more devices that (i) print hard copies and (ii) are configured for network communication. One example is a network-connected print server 86 and a printer 88 connected thereto. “Print data” refers to data usable by a printer system for printing hard copy documents 72.) Subsequently, the terminal 74 transmits the print data 82 to the printer system 84 over the network communication link 80. The printer system 84 automatically prints hard copy documents 72 based on the print data 82, for later retrieval by the user.

The system 70 of the present invention may be implemented on or in conjunction with an IMS network 10. The IMS network 10 is a communication network having (or working in conjunction with) an IP Multimedia Subsystem, e.g., as generally illustrated in FIG. 1. The IMS network 10 includes an IMS portion and a number of IP (Internet protocol)-based and other networks functionally interconnected by the IMS. The IMS-interconnected networks may include the Internet 36, PSTN's 24 and other wire-line networks, and wireless networks 40, 42 such as those using CDMA, GSM, IEEE 802.11x, and/or UMTS communications or the like. In addition to implementation on an IMS network 10, the system 70 may be implemented on any public wide area network, meaning a communication network covering a wide geographic area, for example, an area greater than a campus or other grouping of related, proximately situated buildings, which network is accessible by a number of unrelated individuals/groups for general purpose communications. Thus, the print service system 70 allows users to print documents, even if the terminals and printer systems are electronically remote from one another. By “electronically remote,” it is meant not directly connected via a terminal-to-terminal connection or local area network (LAN), which may infer that the terminal and printer system are (i) physically separated by a significant distance, e.g., not in the same building, and/or (ii) are connected to disparate networks, e.g., separated LAN's controlled by different third parties.

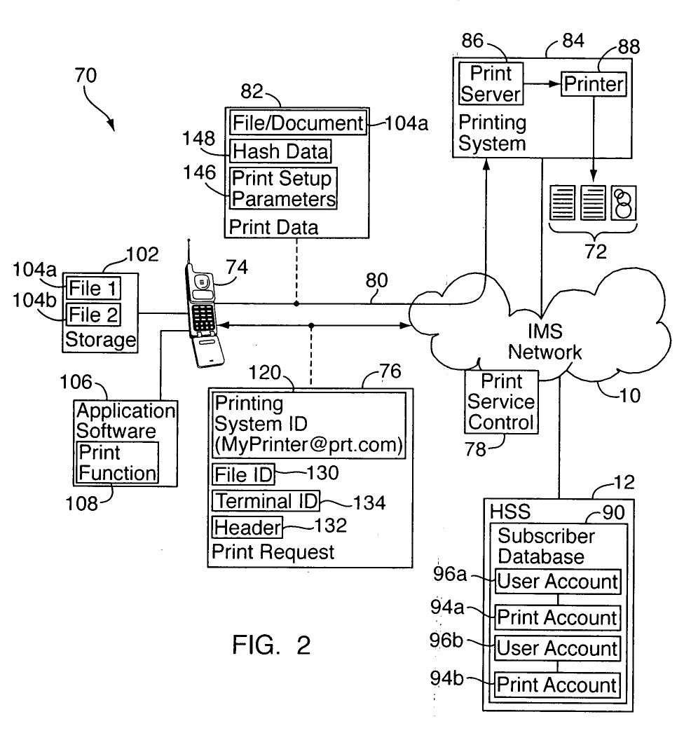

Although only one terminal 74 and printer system 84 are shown in FIG. 2 for clarity of illustration, it will typically be the case that the system 70 accommodates and is used by a plurality of users, terminals, and printer systems. Each terminal 74 is an electronic device capable of communicating with other devices over the network 10, and may include, for example, computers, “WiFi”-equipped computers, and wireless units such as mobile phones, wireless PDA's, wireless devices with high-speed data transfer capabilities, such as those compliant with “3-G” or “4-G” standards, and the like. The terminals 74 communicate over the network 10 in a standard manner, depending on the network's communication protocols and on the operational characteristics of the terminals. For example, in the case of wireless units and a wireless network 42, the network 42 may include one or more fixed base stations (not shown) having various transceivers and antennae for wireless, radio-frequency (RF) communications with the wireless units over one or more RF channels, in a manner based on the wireless communication method and protocols used. Additionally, in the case of an IMS network 10, the terminals will be configured to communicate using IP-based or other packet data communications such as TCP/IP.

An embodiment of the print service system 70 will now be discussed in more detail with respect to FIGS. 2-4B. As indicated in FIG. 2, the print service system 70 includes a user terminal 74, the printer system 84, the print service controller or control sub-system 78, and an HSS (home subscriber server) subscriber database 90. The print service control sub-system 78 coordinates the central operation of the system 70, and comprises one or more electronic hardware modules, hardware/software modules, scripts or other software programs, and/or suites of software programs, which are part of the network 10 and/or which are configured to operably interact with the network 10 for carrying out the functions of the system 70. (In other words, in addition to having one or more printer system-specific functional components, the control sub-system 78 may utilize existing network components for implementing the system 70.) The print service control sub-system 78 may be deployed at one or more locations (physical or functional) in the network, e.g., as part of the HSS 12, on an application server 20, or the like. Thus, when it is referred to herein that the terminal 74 and printer system 84 communicate with the control sub-system 78, it is meant that they communicate with the sub-system and/or with another designated element in the network 10 which functions in conjunction with the control sub-system 78 for the particular purpose at hand.

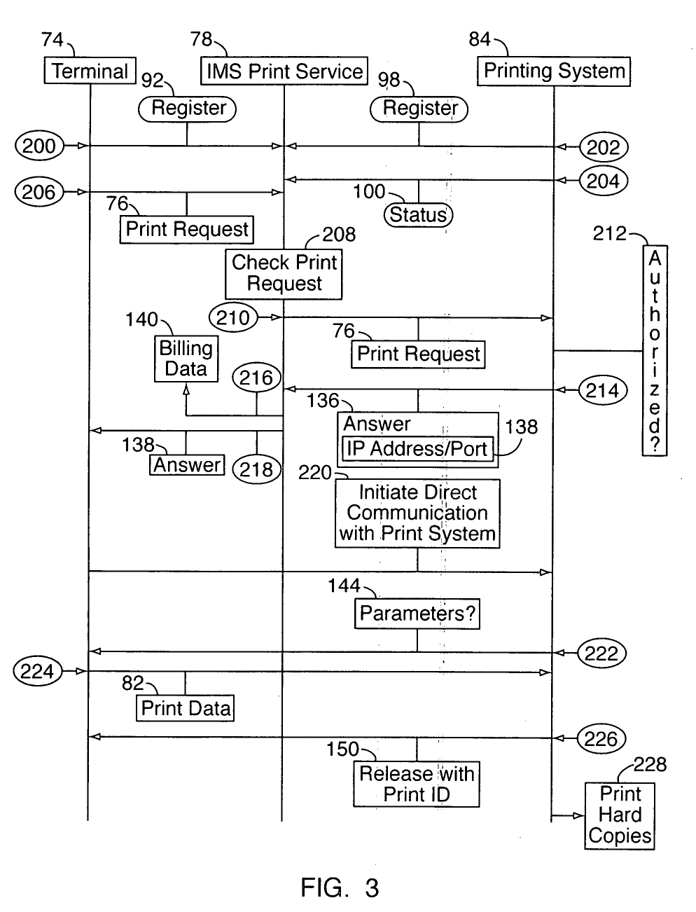

Initially, for using the system 70, the terminal 74 and printer system 84 register with the print service control sub-system 78. The printer system 84 is a printer system to which the user of the terminal 74 has access in one manner or another, e.g., personal, office-related, or commercial. At Step 200 (FIG. 3), the user of the terminal 74 initiates transmission of a print service “register” message 92 or the like to the control sub-system 78. The register message 92 includes a communication identifier associated with the terminal 74 and/or user, an implied or explicit indication that the terminal is to be registered for use with the print service system 70 (e.g., an explicit instruction, and/or transmission of the message 92 to a designated registration network address), and possibly other data. Based on the register message 92, the control sub-system 78 establishes a print account 94a for the user or terminal 74, which may be part of, or otherwise associated with, an account 96a of the user or terminal in the HSS subscriber database 90. (Typically, there will be a plurality of print accounts 94a-94b and user accounts 96a-96b, which are respectively associated with the terminals 74 and users that have registered with the system 70.) At Step 202, the printer system 84 is similarly directed to register with the control sub-system 78, by transmitting a register message 98 thereto. The message 98 may include (i) a special register header indicating it is from a printer system, and (ii) a printer system URL or other network address or communication identifier 120 such as MyPrinter@prt.com. Alternatively, the URL may be assigned by the system 70 or network 10.

At Step 204, the printer system 84 periodically regularly transmits status messages 100 to the control sub-system 78. The status messages 100 indicate whether the printer system 84 is “on line,” e.g., currently able to receive print data 82 and/or generate hard copies 72 based on received print data 82. When the control sub-system 78 receives a print request 76, it determines whether the printer system addressed in the print request is on line, as indicated in the most recent status message 100 received from the printer system 84. If not, the print request is denied or postponed until the printer system is back on line.

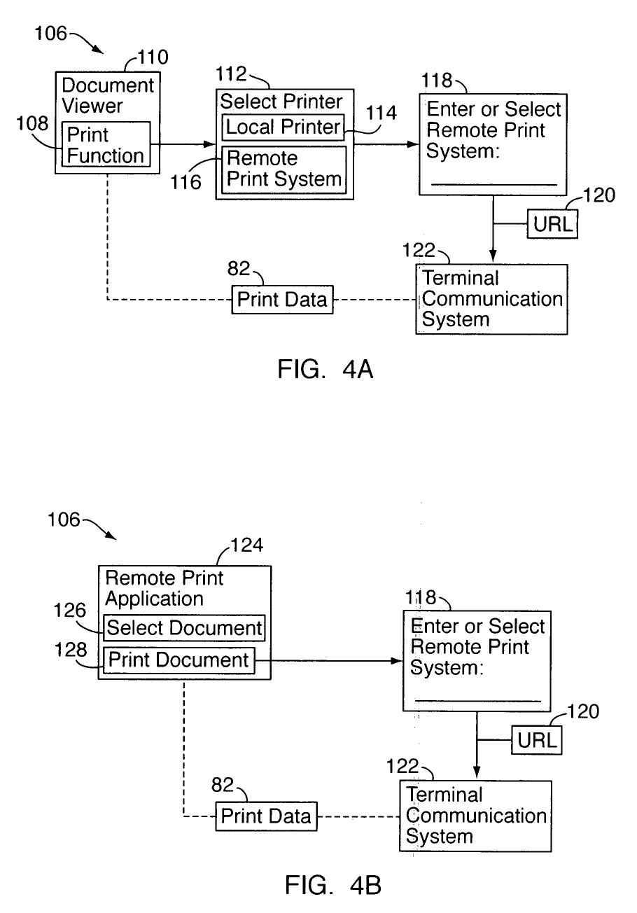

As shown in FIG. 2, the terminal 74 includes temporary or permanent memory or other storage 102 containing one or more files 104a, 104b. For example, the file 104a might be a picture file containing an image that the user recently captured using a camera function on the terminal 74. The terminal 74 also includes a software application or program 106, which has a “print” function 108. The application 106 may be general-purpose application software configured for use on the terminal, or it may be specific to the system 70 and provided to the terminal as a download upon registration, as at Step 200. In either case, if a user desires to remotely print a file 104a from the terminal 74, the file 104a is accessed or otherwise selected through the application software 106. Then, the user selects the print function 108. The user is presented with an option (e.g., text entry field) allowing for the input of a URL or other communication identifier 120 of a printer system. Two examples of possible application software 106 are shown in FIGS. 4A and 4B. In FIG. 4A, the application software 106 on the terminal 74 is a general-purpose document viewer program 110, which has a print function 108. Upon accessing a file 104a in the document viewer 110, the user selects the print function 108. The user is then presented with a “select printer” function 112 displayed on the terminal 74. The user has the option of selecting among one or more printer options, e.g., a local printer option 114 and a remote printer system option 116. (As should be appreciated, upon registering with the print service 70, the remote printer system option 116 would be added to the terminal, by way of a plug-in module, software download, instruction, or the like, e.g., akin to configuring a print server for accessing a newly connected printer.) Upon selecting the remote print option 116, a selection field 118 is displayed, allowing the user to enter or select a printer system URL or other identifier 120. After entering or selecting the URL 120, the terminal's communication system 122 is accessed for initiating communications with the network 10 to commence transmission of the print request 76, etc. The application software 106 in FIG. 4B is similar, but instead comprises a remote print application 124, which functions solely for a user to select and remotely print a document through the system 70. Thus, the remote print application 124 might include a “select document” or “select file” function 126 and a “print document” function 128. Numerous other configurations are possible.

Once the user has selected a file 104a and initiated remote printing to a selected printer system 84, at Step 206 the terminal 74 generates and transmits a print request 76 over the network 10. The print request 76 includes one or more of the following: the URL or other identifier 120 of the printer system 84, e.g., MyPrinter@prt.com, an identifier 130 of the selected file 104a, a header 132 indicating that the communication is a print request message 76, and an identifier 134 associated with the terminal or user 74. At Step 208, the control sub-system 78 verifies the print request 76 based on the URL or other identifier 120. For example, the control sub-system 78 may determine if the URL 120 is associated with a printer system. Additionally, as noted above, the control sub-system 78 may cross reference the URL 120 to the latest status message 100 received from the identified printer system 84. If the print request is valid, the control sub-system 78 forwards the print request 76 to the printer system 84, as at Step 210. (If needed, the terminal or user identifier 134 is appended to the print request at this time.) At Step 212, the printer system 84 receives the print request 76, and determines whether the print request is from an authorized user or terminal. Typically, this is done by comparing the terminal identifier 134 (or a user identifier) from the print request 76 to a list of authorized identifiers stored in the printer system. If authorized, at Step 214 the printer system 84 transmits an answer message 136 to the control sub-system 78. The answer message 136 contains a network address 138, e.g., IP address and port, of the printer system 84. If not, the printer system 84 may simply not respond, or it may send a message indicating that the user or terminal is not authorized to print using the printer system 84.

At Step 216, if the control sub-system 78 receives an answer message 136 indicating that the terminal/user is authorized, it generates billing data 140 relating to the transfer of the print data 82 from the terminal 74 to the printer system 84. This may involve: (i) generating a billing entry in the print account 94a or user account 96a or elsewhere; (ii) notifying a network billing sub-system about the transaction; or (iii) a similar operation. The billing data may be used to charge the user a monetary amount for utilizing the print service system 70. The billing data may be based on the type and amount of print data 82 and/or hard copies 72.

At Step 218, the control sub-system 78 forwards the answer message 136 to the terminal 74, which now has the network address 138 to which the print data 82 may be transmitted. As should be appreciated, the aforementioned steps carried out by the control sub-system 78 in processing control messages between the terminal and printer system may be considered the establishment of a communication link or channel between the terminal and printer system, as relating to the print transfer function of the system 70. In other words, the control sub-system 78 facilitates the authorized transfer of print data on an application layer above the signaling protocol layer and physical layer in place on the network for actually transmitting data. Thus, the communication link or channel established by the control sub-system 78 is a negotiated application-layer authorization for the transfer of print data from the terminal to the printer system.

At Step 220, the terminal 74 initiates direct communication with the printer system 84 over the communication link 80, according to the communication protocols in place on the network 10. For example, the terminal 74 may execute a TCP handshake with the printer system. Subsequently, at Step 222 the printer system 84 transmits a set of available print setup parameters 144, such as number of copies, paper source, output tray, print size, print effects, and the like. In other words, the parameters 144 relate to the user-selectable system capabilities and options of the printer system, which will depend on the type and configuration of the printer system. The user selects the desired parameters, and initiates the print function 108. (For example, the parameters may be displayed on the terminal 74. The user configures the parameters as desired and then selects a final “print” function, similar to the “print document” feature of a word processing program.) At Step 224, the terminal 74 transmits the print data 82 to the printer system 84, addressed according to the printer system's network address 138. The print data 82 may include: the selected data file 104a; data relating to the selected print setup parameters 146; user or terminal identifying information 134; and hash data 148, which is data used for reassembling the other print data, e.g., the print data is typically transmitted in packet form, and the hash data is used to reconstitute the file 104a and other print data from the data packets. The print data 82 may also contain other information.

After receiving the print data 82, the printer system 84 checks the integrity of the file 104a and other print data 82 based on the hash data 148. If there are no errors, the relevant portion of the print data 82 (e.g., file 104a and parameters 146) is entered into the printer system's process queue. At Step 226, the printer system 84 transmits a release message 150 to the terminal 74, either directly over the network or through the control sub-system 78. The release message 150 contains a print job identifier, which the terminal displays for the user. At Step 228, the printer system 84 processes the print data in the queue, and generates hard copy documents 72 according to the file 104a and print setup parameters 146. If the printing operation is completed successfully, the printer system 84 may transmit a message to the terminal with the print job ID and print job status, notifying the user that the hard copy documents 72 are ready for pickup. When the user is next able to access the physical location of the printer system 84, the user retrieves the printed documents 72.

The system 70 may be used in a personal or office context, for transferring print data from a remote terminal to a home or office printer system to which the user has access. Additionally, the system 70 may be implemented in a commercial context, where users are informed of a remote printer system to which they may send print data for a fee. For example, the printer system could be located at a copy shop, office supply store, or photography shop. Users would be informed of the printer system's capabilities (e.g., text document printing, photo printing, or the like) and network address or other communication identifier in advance, e.g., by way of an advertisement or webpage. Here, instead of cross-referencing the terminal or user identifier to a list of authorized users, the authorization process (Step 212) might involve a payment transaction corresponding to the number and/or type of document hard copies 72 to be printed. In particular, the user would be prompted to enter payment information, and if the payment were completed successfully, then the user/terminal would be deemed authorized to transmit print data for printing at the printer system. Alternatively or in addition, the user could set up an account with the commercial establishment, in which case authorization would be carried out in a manner similar to as described above at Step 212.

As should be appreciated, the authorization process (Step 212) may be carried out by the control sub-system 78, based on information received from the printer system 84. For example, the sub-system 78 could maintain an account listing or database entry for the printer system, which would contain a list of the users or terminals authorized for accessing the printer system. The printer system 84 would periodically send updates of the list to the printer system 84 for updating the corresponding list in the printer system's account. Additionally, instead of determining authorization status based on terminal identifier, this may be done according to a user identifier or the like. For example, the system could be configured for a user to enter an account name and password into the terminal for accessing the printer system, which would be transmitted to the printer system as part of the print request 76.

Although the terminal 74 is illustrated as transmitting a file 104a as the content portion of the print data 82, the content portion could instead originate from temporary memory, an input device, or elsewhere.

The printer 88 may be any type of printing device, such as a laser printer, dot matrix printer, ink jet printer, photo printer, plotter, commercial offset printing press, or the like, or even an “indirect” printer such as a fax machine.

Since certain changes may be made in the above-described print service for IMS network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of transferring data over a network, said method comprising the steps of:
establishing a communication link for transfer of print data from a terminal to a printer system over the network, upon receipt of a print request from the terminal,
wherein the network is a wide area network.

2. The method of claim 1 wherein the network is an IMS network having a wireless network portion, and the terminal is a wireless unit.

3. The method of claim 2 wherein the wireless unit is at a first location, and the printer system is at a second location remote from the first location, said printer system including at least one printer.

4. The method of claim 2 wherein the printer system is configured to automatically print at least one hard copy document subsequent receipt of the print data from the terminal over the network.

5. The method of claim 4 further comprising:
generating billing data relating to the transfer of the print data from the terminal to the printer system, said billing data being associated with the terminal.

6. The method of claim 4 wherein the communication link is established based at least in part on (i) at least one status message received from the printer system and on (ii) the print request received from the terminal, said status message indicating a status of the printer system for automatically printing the at least one hard copy document, and said print request including an identifier of the printer system for associating the print request with the status message.

7. The method of claim 6 further comprising:
generating billing data relating to the transfer of the print data from the terminal to the printer system, said billing data being associated with the terminal.

8. The method of claim 6 wherein the printer system identifier is a network URL.

9. The method of claim 6 further comprising:
determining if the terminal is authorized to transfer said print data to the printer system based at least in part on the print request message.

10. The method of claim 6 further comprising:
transmitting a network address of the printer system to the terminal, said network address comprising at least one of a network IP address and a network port of the printer system, wherein the print data is addressed to said at least one of the network IP address and the network port of the printer system.

11. The method of claim 6 further comprising:
registering said printer system and said terminal for transfer of said print data over the network, based at least in part on registration request communications received from the printer system and terminal.

12. A method of transferring data over a network, said method comprising the steps of:
determining whether a print request received from a terminal over the network is an authorized print request; and, if so,
automatically printing at least one hard copy document based on print data received from the terminal, wherein the network is a wide area network.

13. The method of claim 12 wherein the network is an IMS network having a wireless network portion, and the terminal is a wireless unit, said wireless unit being at a first location remote from a second location of where the hard copy document is printed.

14. The method of claim 13 wherein the determination of whether the print request is an authorized print request is based at least in part on an identifier included in the print request message, said identifier being associated with at least one of the terminal and a user of the terminal.

15. The method of claim 13 further comprising:
registering with the IMS network for receiving print requests and print data over the IMS network.

16. The method of claim 13 further comprising:
periodically transmitting status messages to the IMS network, said status messages relating to the availability of automatic printing of hard copy documents upon receipt of authorized print requests over the network.

17. A method of transferring data over a network, said method comprising the steps of:
transmitting a print request message over the network, said print request message including an identifier associated with a printer system; and
transmitting print data to the printer system over the network, said print data including a network address of the printer system received in a print request answer message,
wherein the network is a wide area network.

18. The method of claim 17 wherein the network is an IMS network having a wireless network portion, and wherein the print request message is transmitted wirelessly over the wireless network portion of the IMS network.

19. The method of claim 18 further comprising:
transmitting hash data associated with the print data for reassembly of the print data by the printer system.

20. The method of claim 18 further comprising:
registering with the IMS network for transmission of print data to the printer system.
